(19) United States
(12) Patent Application Publication
(10) Pub. No.: US 2026/0121542 A1
(43) Pub. Date: Apr. 30, 2026

(54) PRE-CHARGE MONITORING OF POWER STAGE CIRCUIT FOR MULTIPHASE VOLTAGE REGULATOR

(71) Applicant: Monolithic Power Systems, Inc., Kirkland, WA (US)

(72) Inventors: Wei-Chung Chen, Zhubei City, Hsinchu County (TW); Le Kong, San Jose, CA (US); Cong Deng, San Jose, CA (US); Yu-Huei Lee, New Taipei City (TW)

(21) Appl. No.: 18/926,226

(22) Filed: Oct. 24, 2024

(51) Int. Cl. H02M 3/158; G01R 19/165; H02M 1/00

(52) U.S. Cl. CPC H02M 3/1586; G01R 19/16576; H02M 1/0009

(57) ABSTRACT

A control circuit for a multiphase voltage regulator includes a switching control circuit and a monitor circuit. The switching control circuit is configured to provide a control signal to control a plurality of power stage circuits. Each of the power stage circuit is configured to provide a phase current. The monitor circuit is configured to receive a report signal from at least one of the power stage circuits, and determine whether the report signal indicates a pre-charge period of the corresponding power stage circuit is finished. After the report signal indicates that the pre-charge period of the corresponding power stage circuit is finished, the control signal is provided to power on the corresponding power stage circuit.

### TECHNICAL FIELD

The present disclosure relates generally to power circuits, and more particularly but not exclusively to multiphase voltage regulators.

### BACKGROUND OF THE INVENTION

Multiphase voltage regulator has been widely used in high power applications. The multiphase voltage regulator includes multiple (e.g., n) power stage circuits, where n is a positive integer greater than 1. Specifically, the n power stage circuits are coupled in parallel, and each of the power stage circuit to provide a higher output current to the load. Each power stage circuits is configured to share the input voltage and the output voltage and provide a phase current to a load. In one embodiment, the n power stage circuits are interleaved in n phases to reduce current ripple at the input and output and improve efficiency. Typically, each of the n power stage circuits is an integrated circuit (IC), and a multiphase controller is also an IC configured to provide the n phase control signals to respectively control the n power stage ICs. Therefore, it is important for the multiphase controller IC to monitor the status of the power stage ICs to provide the regulated output voltage. As a result, it is desirable to provide the status report of power stage IC.

### SUMMARY OF THE INVENTION

According to an embodiment of the present disclosure, a control circuit for a multiphase voltage regulator is provided. The control circuit includes a switching control circuit and a monitor circuit. The switching control circuit is configured to provide a control signal to control a plurality of power stage circuits. Each of the power stage circuit is configured to provide a phase current. The monitor circuit is configured to receive a report signal from at least one of the power stage circuits, and determine whether the report signal indicates a pre-charge period of the corresponding power stage circuit is finished. After the report signal indicates that the pre-charge period of the corresponding power stage circuit is finished, the control signal is provided to power on the corresponding power stage circuit.

According to yet another embodiment of the present disclosure, a power stage circuit is provided. The power stage circuit includes a switch circuit, a driving control circuit, a pre-charge monitor circuit, and a report circuit. The switch circuit has at least one switch, and one of the at least one switch is configured to be coupled to a flying capacitor. The driving control circuit is configured to receive a control signal and provide at least one driving signal to a control terminal of the at least one switch. The pre-charge monitor circuit is configured to monitor a voltage across the flying capacitor. The report circuit is configured to provide a report signal indicating a pre-charge period of the flying capacitor is finished.

According to yet another embodiment of the present disclosure, a multiphase voltage regulator is provided. The multiphase voltage regulator includes a plurality of power stage circuits, and a control circuit. Each of the power stage circuits is configured to provide a phase current, and each power stage circuit includes at least one power switch and a report circuit. The report circuit is configured to provide a report signal. The control circuit is coupled to the power stage circuits. The control circuit is configured to receive the report signal from at least one of the power stage circuits, determine whether the report signal indicates the pre-charge period of the corresponding power stage circuit is finished; and provide a control signal to the corresponding power stage circuit after it is determined that the report signal indicates the pre-charge period of the corresponding power stage circuit is finished.

According to yet another embodiment of the present disclosure, a method for controlling a multiphase voltage regulator is provided. The method includes the following actions. Reporting signals are received from power stage circuits. Whether the reporting signal indicates a pre-charge period of the corresponding power stage circuit is finished is determined. After the reporting signal indicating the pre-charge period of the corresponding power stage circuit is finished, a control signal is provided to power on the corresponding power stage circuit.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 is a schematic block diagram of a multiphase voltage regulator in accordance with an embodiment of the present disclosure.

FIG. 2A is a schematic circuit diagram of a switching converter in accordance with an embodiment of the present disclosure.

FIG. 2B is a schematic circuit diagram of a switching converter in accordance with another embodiment of the present disclosure.

FIG. 3 is a schematic block diagram of a multiphase controller IC 300 in accordance with an embodiment of the present disclosure.

FIG. 4 is a schematic block diagram of a power stage IC in accordance with an embodiment of the present disclosure.

FIG. 5 is a schematic circuit diagram of a multiphase voltage regulator in accordance with one embodiment of the present disclosure.

FIG. 6 is a flowchart of a method for controlling a multiphase voltage regulator in accordance with one embodiment of the present disclosure.

FIG. 7 is a flowchart of a method for controlling a multiphase voltage regulator in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

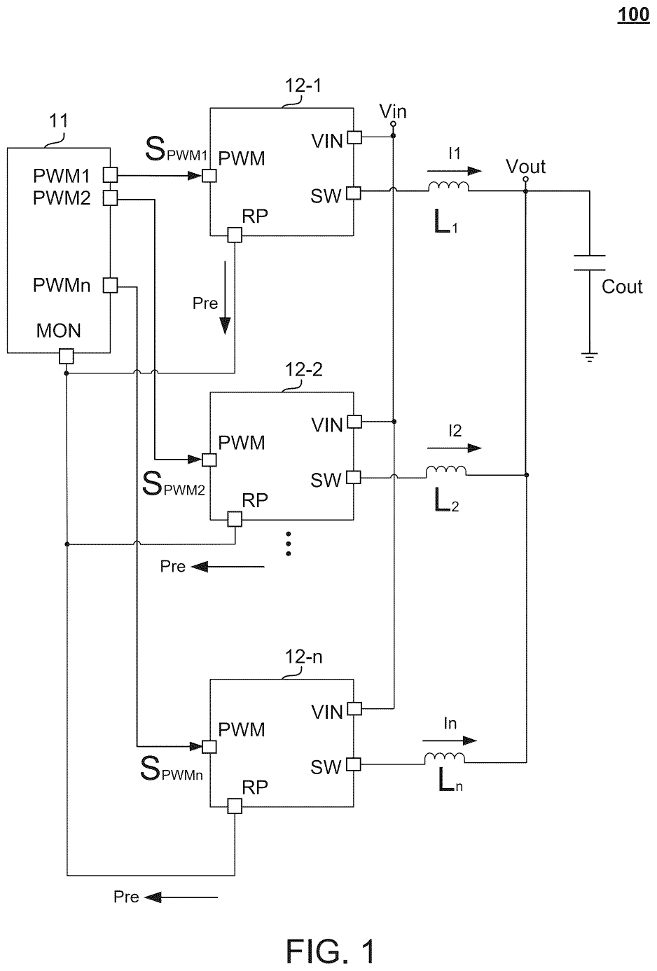

FIG. 1 is a schematic block diagram of a multiphase voltage regulator 100 in accordance with an embodiment of the present disclosure. The multiphase voltage regulator 100 includes a control circuit 11 and multiple (e.g., n) power stage circuits 12-1 to 12-n, where n is a positive integer greater than 1. The n power stage circuits are coupled in parallel, and each of the power stage circuit to provide a phase current to the load. Each power stage circuits is configured to share the input voltage Vin and the output voltage Vout and provide a phase current (e.g., I1, I2, . . . , In) to a load. In one embodiment, the n power stage circuits are interleaved in n phases to reduce current ripple at the input and output and improve efficiency. The control circuit 11 is configured to provide the n phase control signals (e.g., S_{PWM1}, S_{PWM2}, . . . , S_{PWMn}) to respectively control the n power stage circuits.

In one implementation, the multiphase voltage regulator 100 is a multiphase buck converter. However, the present disclosure is not limited thereto. The multiphase voltage regulator 100 may be a multiphase boost converter, a trans-inductor voltage regulator (TLVR), a multiphase DC-DC converters, or any multiphase converters. In some implementations, the multiphase voltage regulator 100 is an isolated converter. In some other implementations, the multiphase voltage regulator 100 is a non-isolated converter.

In one embodiment, the control circuit 11 is a multiphase controller integrated circuit (IC) having n switching control pins (e.g., PWM1-PWMn) and a monitor pin (e.g., MON). In one embodiment, each of the power stage circuits 12-1 to 12-n is an IC. Each of the power stage circuits 12-1 to 12-n includes a VIN pin configured to receive the input voltage Vin, a SW pin configured to provide the output voltage Vout via the inductor (e.g., L₁, L₂, . . . , Lₙ), a switching control pin (e.g., PWM) configured to receive the control signals (e.g., S_{PWM1}, S_{PWM2}, . . . , S_{PWMn}) from the multiphase controller IC 11, and a report pin (e.g., RP) configured to transmit a report signal (e.g., Pre) to the multiphase controller IC 11. The report signal indicates whether the pre-charge period of the corresponding power stage circuit is finished.

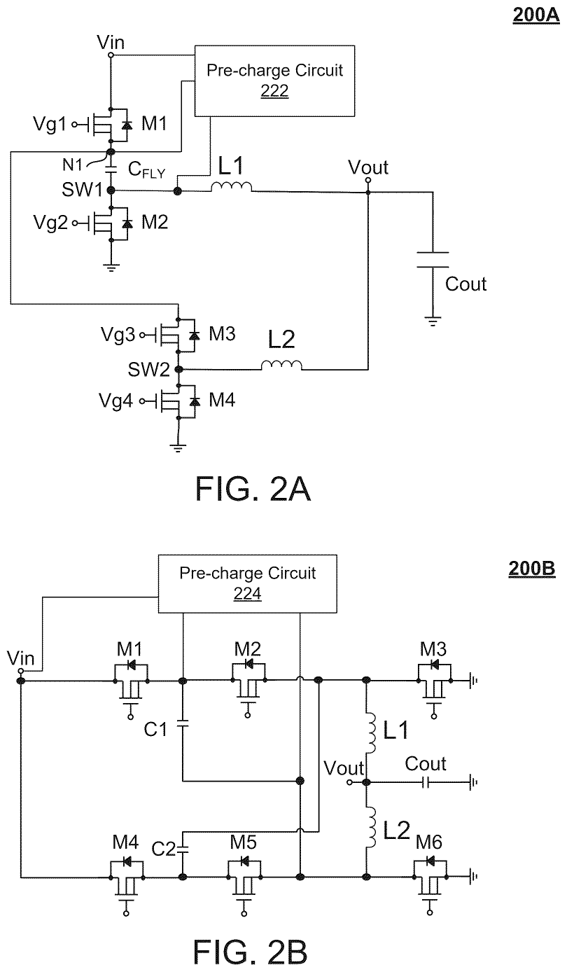

In one embodiment, the multiphase voltage regulator 100 is a converter including one or more flying capacitors. For instance, FIG. 2A is a schematic circuit diagram of a switching converter 200A in accordance with an embodiment of the present disclosure. As shown in FIG. 2A, the switching converter 200A includes a switching circuit, inductors L1 and L2, and a flying capacitor C_{FLY}. In one embodiment, an output capacitor Cout is coupled between the output terminal Vout and a ground. As shown in FIG. 2A, the switching circuit has 4 power switches M1-M4. In one embodiment, the power switches M1-M4 may include Metal-Oxide-Semiconductor Field-Effect Transistor (MOSFETs). In some embodiments, the power switches M1-M4 may include, but not limited to, a bipolar transistor (BJT), a field-effect transistor (FET), or an insulated-gate bipolar transistor (IGBT), a high electron mobility transistor (HEMT), a junction field-effect transistor (JFET), a Gate Turn-off Thyristor (GTO) or a Gate-Commutated Thyristor (GCT). The power switch M1 and the power switch M2 are coupled in series between the input terminal Vin and the ground, and the flying capacitor C_{FLY} is coupled between the power switch M1 and the power switch M2. Specifically, the flying capacitor C_{FLY} is coupled to between the node N1 and the node SW1. The power switches M3 and M4 is coupled in series between the node N1 and the ground. The switching converter 200A is a 2-phase converter. Each phase includes a high side switch (e.g., M1, M3) and a low side switch (e.g., M2, M4), and configured to provide the output voltage via each inductor (L1, or L2). The flying capacitor C_{FLY} acts as a voltage divider to divide the input voltage VIN. The flying capacitor C_{FLY} temporarily stores energy during a switching cycle and transfer energy to the output stage, and the temporarily stored energy is proportional to the duty cycle. During steady state, the voltage across the flying capacitor C_{FLY} is the output voltage Vo divided by the duty cycle D. In one implementation, the voltage across the flying capacitor C_{FLY} is approximately half of the input voltage (½*VIN) at steady state.

For example, in a first interval, the power switches M1 and M4 are turned on, and the power switches M2 and M3 are turned off. In this interval, the input current flows through the power switch M1, the flying capacitor C_{FLY}, and the inductor L1 to the output terminal Vout, while the current in inductor L2 flows through power switch M4 to the output terminal Vout. The current in inductor L1 increases, and the current in inductor L2 decreases. The input voltage V_{IN} is divided between the flying capacitor C_{FLY} and the output stage.

In a second interval, the power switch M1 is turned off and the power switch M2 is turned on, the current in inductor L1 flows through the power switch M2, and therefore the energy stored in inductor L1 starts to discharge to the output terminal Vout, while the current in inductor L2 continues to decrease.

In a third interval, the power switch M3 is turned on and the power switch M4 is turned off. During this interval, the current in inductor L2 flows through the power switch M2, the flying capacitor C_{FLY}, the power switch M3, and the inductor L2 to the output terminal Vout, while the current in inductor L1 flows through the power switch M2 to the output terminal Vout. The current in inductor L2 increases, and the current in inductor L1 decreases.

In a fourth interval, the power switch M3 is turned off, which is identical to the second interval. During this interval, both power switches M1 and M3 are off and both power switches M2 and M4 are on, and both inductor currents decrease. Afterwards, the circuit enters a new switching cycle when the power switch M1 is turned on again.

In one embodiment, a pre-charge circuit 222 is coupled to the input terminal Vin and at least one terminal (e.g., N1 and/or SW1) of the flying capacitor C_{FLY} to charge the flying capacitor C_{FLY} during start-up of the switching converter 200A.

In one embodiment, the switching converter 200A further includes a control circuit (not shown) is configured to provide switching control signals Vg1-Vg4 to control the power switch devices M1-M4 respectively.

FIG. 2B is a schematic circuit diagram of a switching converter 200B in accordance with another embodiment of the present disclosure. In this embodiment, the switching converter 200B includes two flying capacitors C1 and C2. As shown in FIG. 2B, the switching circuit has 6 power switches M1-M6. The switching converter 200B is a 2-phase converter. The first phase includes the power switch M1, the flying capacitor C1, the power switches M5 and M6, and the inductor L2. The second phase includes the power switch M4, the flying capacitor C2, the power switches M2 and M3, and the inductor L1. In one embodiment, a pre-charge circuit 224 is coupled to the input terminal Vin and at least one terminal of the flying capacitor (e.g., C1 and/or C2) to charge the flying capacitor (e.g., C1 and/or C2) during start-up of the switching converter 200B.

FIGS. 2A and 2B show buck type switching converter with one and two flying capacitor. However, the present disclosure is not limited thereto. In another embodiment, the switching converter is a boost type converter. In some embodiments, the switching converter is a buck-boost type converter. In some other embodiments, the switching converter is a switched capacitor type converter. In one implementation, the switching converter includes one or more flying capacitor coupled between at least one of the power switch. In one example, one or more flying capacitor is coupled at the input circuit that is between the input terminal and the inductor. In another example, one or more flying capacitor is coupled at the output circuit that is coupled to the output terminal.

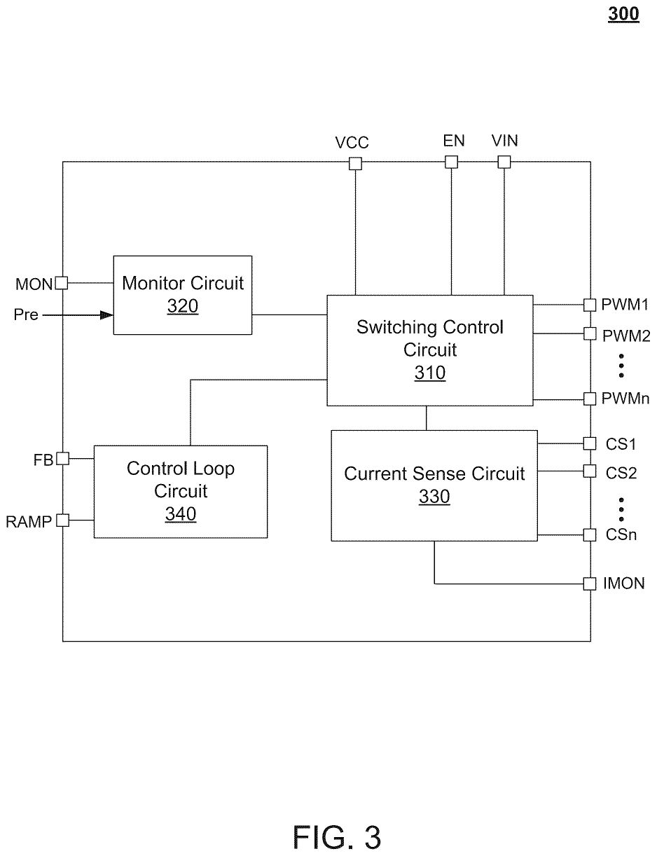

FIG. 3 is a schematic block diagram of a multiphase controller IC 300 in accordance with an embodiment of the present disclosure. The multiphase controller IC 300 includes a switching control circuit 310, and a monitor circuit 320. The switching control circuit 310 is configured to provide control signals via the switching control pins (e.g., PWM1, PWM2, . . . , PWMn) to control the power stage circuits. The monitor circuit 320 is configured to receive a report signal (e.g., Pre) via the monitor pin (e.g., MON), and determine whether the report signal Pre indicates a pre-charge period of the corresponding power stage circuit is finished. In one embodiment, the monitor pin MON is configured to receive the status of one of the power stage circuits, and the report signal Pre is received via the monitor pin MON. For example, the status of the power stage circuit indicates an event or a warning. In one implementation, different voltage levels of the monitor pin MON are configured to indicate different events or warnings, and whether the pre-charge period of the corresponding power stage circuit is finished. In some implementations, the report signal Pre is a digital signal configured to represent various fault types, warning and whether the pre-charge period of the corresponding power stage circuit is finished. Accordingly, the monitor circuit 320 is configured to receive a report signal Pre via the monitor pin MON, and determine whether the report signal Pre indicates the pre-charge period of the corresponding power stage circuit is finished. In one embodiment, the monitor circuit 320 is configured to compare the report signal with a voltage threshold and generate a comparison signal in response to the report signal and the voltage threshold; and determine whether the pre-charge period of the corresponding power stage circuit is finished according to the comparison signal. For instance a comparator is configured to compare the report signal Pre with a voltage threshold. When the report signal Pre is less than the voltage threshold, the monitor circuit 320 is configured to determine that the pre-charge period of the corresponding power stage circuit is finished.

In one embodiment, the multiphase controller IC 300 further includes a current sense circuit 330 configured to receive current sense signals indicating the respective phase currents of the power stage circuits via the current sense pin (e.g., CS1, CS2, . . . , CSn). In one embodiment, the current sense signals are used to provide a total load current sense signal via the pin IMON.

In one embodiment, the multiphase controller IC 300 further includes a control loop circuit 340 configured to regulate the output voltage Vout. For example, the control loop circuit 340 sense the feedback voltage via the feedback pin FB. The feedback voltage represents the output voltage Vout. In one embodiment, the feedback voltage is compared with a reference signal to generate a compensation signal (e.g., via an error amplifier EA), and the compensation signal is compared with a ramp signal received via the pin RAMP to generate a control signal (e.g., via a PWM comparator). In another embodiment, the feedback voltage is compared with a reference signal to generate a compensation signal (e.g., via an error amplifier EA), and the compensation signal is compared with the inductor current to generate the control signal (e.g., via a PWM comparator). In yet another embodiment, the feedback voltage is compared with a reference signal to generate a compensation signal (e.g., via a PWM comparator), and the control signal is generated in response to the compensation signal and an on-time.

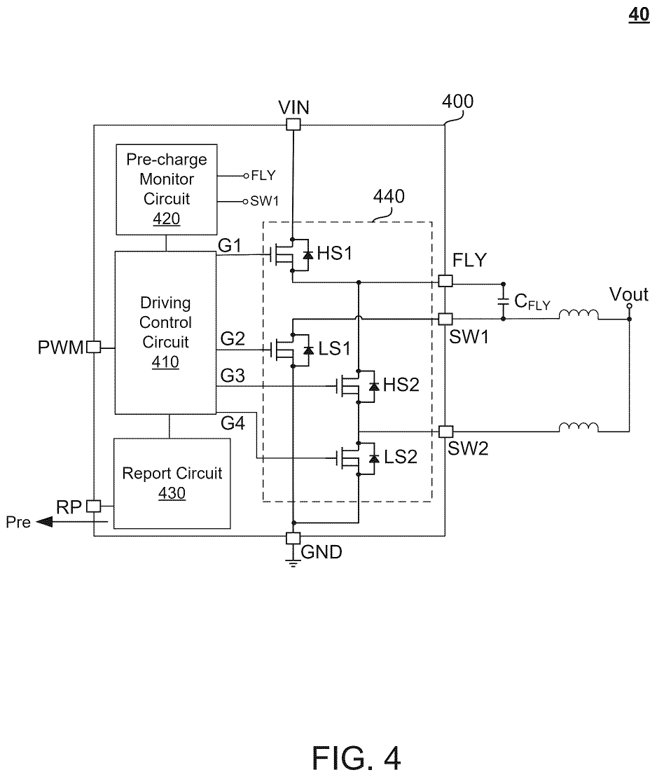

FIG. 4 is a schematic block diagram of a power stage IC 400 in accordance with an embodiment of the present disclosure. The power stage IC 400 includes a switching circuit 440, a driving control circuit 410, a pre-charge monitor circuit 420, and a report circuit 430. The switch circuit 440 has at least one switch, and one of the at least one switch is configured to be coupled to a flying capacitor. In one embodiment, the power stage IC 400 are used to form the converter 200A as shown in FIG. 2A. In one implementation, the power switches HS1, LS1, HS2 and LS2 are n-type MOSFETs. The first terminal (e.g., drain) of a first high-side switch HS1 is coupled to the VIN pin configured to receive the input voltage, the second terminal (e.g., source) of the first high-side switch HS1 is coupled to a flying capacitor C_{FLY} via the FLY pin, and the first terminal (e.g., drain) of the first low-side switch LS1 is coupled to the second terminal (e.g., source) of the first high-side switch HS1 via the flying capacitor C_{FLY}. The second terminal (e.g., source) of the first low-side switch LS1 is coupled to the GND pin configured to be coupled to a reference voltage level (e.g., the ground). The first terminal (e.g., drain) of the second high-side switch HS2 is coupled to the second terminal (e.g., source) of the first high-side switch HS1, the second terminal (e.g., source) of the second high-side switch HS2 is coupled to the SW2 pin and the first terminal (e.g., drain) of the second low-side switch LS2. The second terminal (e.g., source) of the second low-side switch LS2 is configured to be coupled to the reference voltage level (e.g., the ground).

The control terminals (e.g., gate) of the power switches (e.g., HS1, LS1, HS2 and LS2) are coupled to the driving control circuit 410. The driving control circuit 410 is configured to receive a control signal from the switching control pin PWM and provide the driving signals G1-G4 to the gate terminals of the power switches HS1, LS1, HS2 and LS2, respectively. Specifically, the power switches HS1, LS1, HS2 and LS2 are turned on and turned off in response to the driving signals G1-G4, respectively, and provide switching signals at the SW1 pin and the SW2 pin. The pre-charge monitor circuit 420 is configured to monitor a voltage across the flying capacitor (i.e., the voltage between FLY pin and SW1 pin). The report circuit 430 is configured to provide a report signal Pre indicating a pre-charge period of the flying capacitor is finished.

In another embodiment, the power stage IC 400 are used to form the converter 200B as shown in FIG. 2B. However, the present disclosure is not limited thereto. The switching circuit 440 of the power stage IC 400 includes multiple switches with at least one of the switches is configured to be coupled to one or more flying capacitor. That is, the power stage IC may be used to form various types of converter topology.

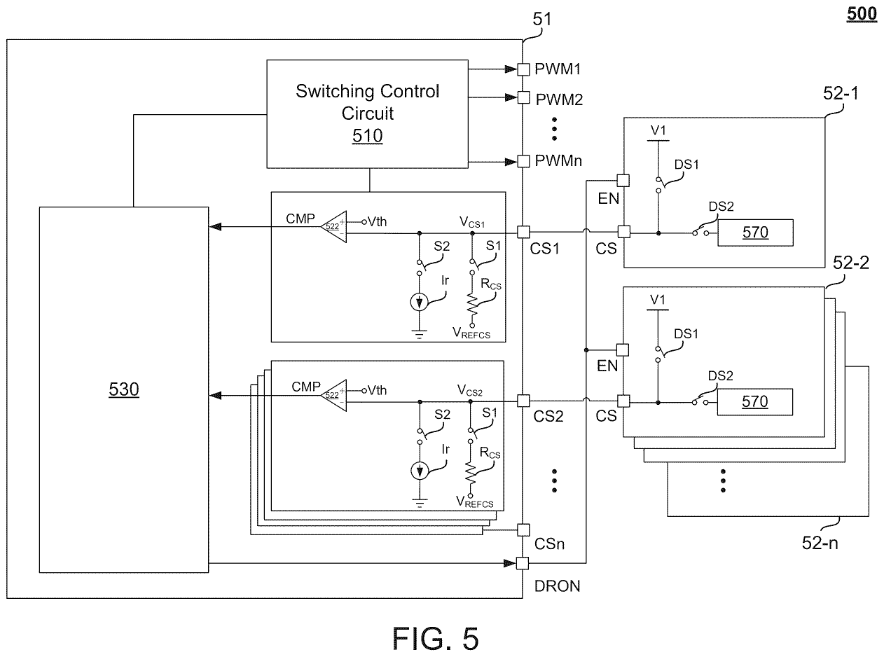

FIG. 5 is a schematic circuit diagram of a multiphase voltage regulator 500 in accordance with one embodiment of the present disclosure. In this embodiment, the report signal Pre is realized by the voltage signal received via the current sense pin (e.g., CS1 to CSn). For instance, during an initial period, that is before the multiphase voltage regulator 500 is powered on, all of the power stage ICs 52-1 to 52-n are not powered on. Each power stage IC needs to pre-charge the flying capacitor before power-on. The power stage IC monitors the voltage across the flying capacitor, and issues the report signal Pre to notify the multiphase controller IC 51 that the pre-charge period of the flying capacitor is finished. For instance, the report circuit of the power stage IC includes a switch DS1 coupled to a reference voltage V1 (e.g., the supply voltage Vcc). Specifically, during the initial period, the current report circuit 570 is disconnected, for example, by turning off the switch DS2. Meanwhile, the switch DS1 is turned on, and thus the voltage of the corresponding current sense pin (CS) is pulled up to the reference voltage V1. When the power stage IC determines that the pre-charge period of the flying capacitor is finished, the switch DS1 is turned off to provide no driving voltage on the current sense pin CS.

On the other hand, during the initial period, the multiphase controller IC 51 detects the voltage of the corresponding current sense pin (CS1-CSn). Specifically, each of the current sense pin (CS1-CSn) is configured to receive a current sense signal (e.g., V_{CS1} to V_{CSn}) from the corresponding power stage IC. In one embodiment, the current sense circuit includes a current sense resistor R_{CS}, and the current could be calculated according to the voltage across the current sense resistor (e.g., V_{CS1}-V_{REFCS}) and the resistance of the current sense resistor R_{CS}. In one embodiment, the monitor circuit includes multiple voltage reference circuits coupled to the current sense pins CS1-CSn. The voltage reference circuit is configured to connect the corresponding current sense pin CSx to a voltage reference. In one implementation, the voltage reference circuit includes a current source Ir. In another implementation, the voltage reference circuit includes a resistor. In some implementations, the voltage reference circuit includes a transistor. During the initial period, the switch S1 is turned off to disable the current sense circuit. Meanwhile, the switch S2 is turned on, and the current source Ir is coupled to the current sense pin (e.g., CS1) to pull down the voltage of the corresponding current sense pin (e.g., CS1). In one embodiment, the monitor circuit includes a comparator 522 configured to compare the report signal with a voltage threshold Vth. Since the voltage of the corresponding current sense pin (CS1) is pulled up to the reference voltage V1 of the power stage IC during the pre-charge period, the current source Ir could not pull down the voltage of the corresponding current sense pin (CS1). Therefore, the voltage signal V_{CS1} (i.e., equals to the reference voltage V1) is greater than the voltage threshold Vth, and the control circuit 530 determines that the pre-charge period of the corresponding power stage circuit is not finished. When the pre-charge period of the corresponding power stage circuit is finished, the switch DS1 is turned off, and the voltage of the corresponding current sense pin (e.g., CS1) is pulled down by the current source Ir. That is, when the V_{CS1} is less than the voltage threshold Vth, the control circuit 530 determines that the pre-charge period of the corresponding power stage IC is finished. In one implementation, the signal CMP with a high logic level (e.g., “1”) indicates that the pre-charge period of the corresponding power stage IC is finished, while a low logic level (e.g., “0”) of the signal CMP indicates that the pre-charge period of the corresponding power stage IC is not finished.

In one embodiment, the current sense of the power stage ICs 52-x is connected to the reference voltage V1 and the corresponding current sense pin CSx of the multiphase controller IC 51 is connected to the ground, and the current source Ir is configured to pull down the voltage of the switching control pin. However, in another embodiment, the current sense of the power stage ICs 52-x is connected to the ground and the current source Ir is configured to pull up the voltage of the switching control pin to the supply voltage (e.g., Vcc). Accordingly, the comparator 522 determines that the voltage signal V_{CS1} is greater than the voltage threshold Vth (e.g., 2.5V), it is determined that the pre-charge period of the corresponding power stage IC is finished. In this implementation, the signal CMP with a high logic level (e.g., “1”) indicates the pre-charge period is not finished, while a low logic level (e.g., “0”) of the signal CMP1 indicates the pre-charge period is finished.

In another embodiment, the monitor circuit detects the falling edge of the report signal. When a falling edge of the report signal is detected, the control circuit 530 determines that the pre-charge period of the corresponding power stage IC is finished. For instance, in the embodiment that the current sense of the power stage ICs 52-x is connected to the reference voltage V1 and the corresponding current sense pin CSx of the multiphase controller IC 51 is connected to the ground, a falling edge of the voltage signal V_{CSX} indicates that the pre-charge period is finished. In another embodiment that the current sense of the power stage ICs 52-x is connected to the ground and the corresponding current sense pin CSx of the multiphase controller IC 51 is connected to the supply voltage Vcc, a rising edge of the voltage signal V_{CSX} indicates that the pre-charge period is finished.

During the initial period, the switching control circuit 510 of the controller IC 51 provides the control signal with a high impedance (Hi-Z) mode to all of the switching control pins (e.g., PWM1-PWMn). For example, the voltage of the switching control pin of the power stage IC is at a middle voltage level or a tri-state logic level. In one implementation, the control signal (i.e., the voltage of the switching control pin PWMx) has three states, a high logic level (e.g., 2-3.3V) to turn on the high-side switch, a low logic level (e.g., 0-1V) to turn on the low-side switch, and a tri-state logic level (e.g., 1-2V) to make the multiphase voltage regulator 500 in the Hi-Z mode (or inactive).

After it is determined that the report signal (e.g., V_{CS1}) indicates that the pre-charge period of the power stage IC is finished, the controller IC 51 performs the power-on sequence. For example, the switching control circuit 510 of the controller IC 51 provides the control signal to the corresponding power stage IC via the switching control pin (e.g., PWM1-PWMn). After the initial period, the switch S2 is turned off to disable the pull down current, and the switch S1 is turned on to enable the current sense circuit in normal operation.

In one embodiment, there are multiple switches S1 and S2, current sources Ir, and comparators 522 and 524 coupled between the corresponding current sense pins CSx of each power stage IC 52-x to determine whether the pre-charge period of each power stage IC 52-x is finished. In one implementation, the multiphase controller IC 51 provides the control signal to power on the corresponding power stage IC 52-x when the pre-charge period of at least one of the power stage IC is finished. In some implementations, the multiphase controller IC 51 provides the control signal to power on the corresponding power stage IC 52-x when the pre-charge period of all of the power stage ICs 52-1 to 52-n are finished.

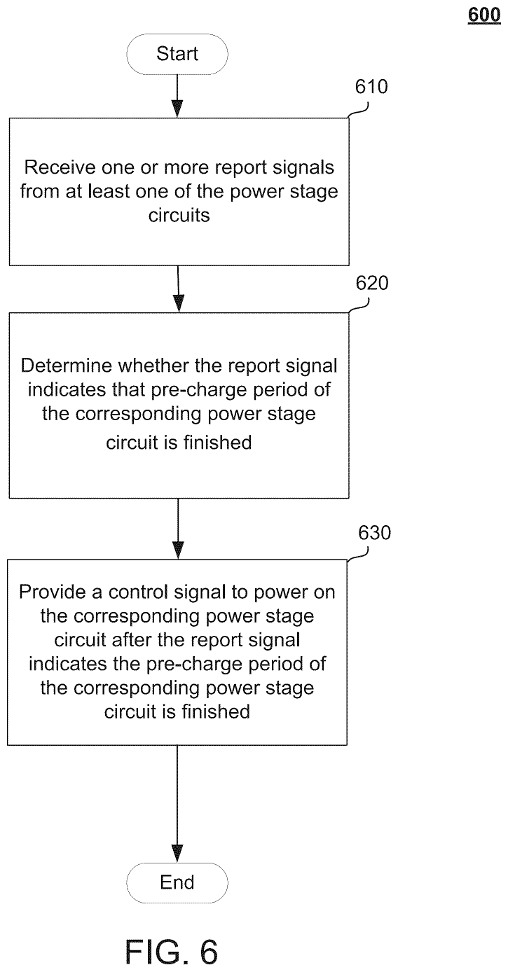

FIG. 6 is a flowchart of a method 600 for controlling a multiphase voltage regulator in accordance with one embodiment of the present disclosure. The method 600 may be performed by a multiphase controller IC 11, 300, 51 as shown in FIGS. 1, 3 and 5. The method includes the following actions. In action 610, one or more report signals are received from at least one of the power stage circuits. In action 620, whether the report signal indicates that pre-charge period of the corresponding power stage circuit is finished is determined. In action 630, a control signal is provided to power on the corresponding power stage circuit after the report signal indicates the pre-charge period of the corresponding power stage circuit is finished.

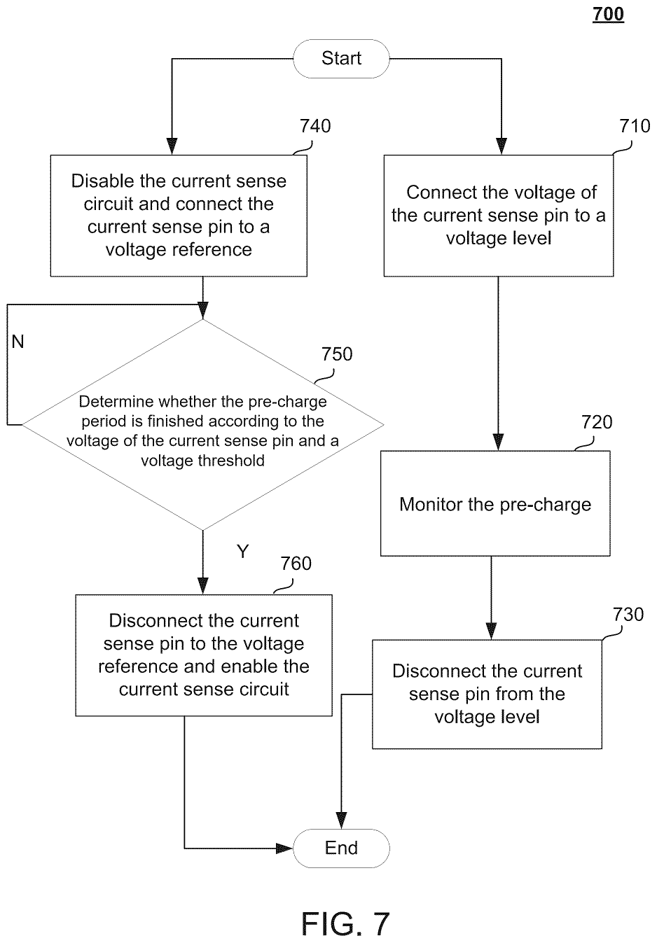

FIG. 7 is a flowchart of a method 700 for controlling a multiphase voltage regulator in accordance with one embodiment of the present disclosure. The method 700 may be performed by a multiphase controller IC 11, 300, 51 as shown in FIGS. 1, 3 and 5 with power stage ICs 12-x, 400, 52-x as shown in FIGS. 1, and 4-5. The method includes the following actions. In one embodiment, the method is performed when the supply voltage (e.g., Vcc) and the enable signal (e.g., EN) of the multiphase controller IC are both ready, and after the multiphase controller send the enable signal (e.g., DRON) to the power stage ICs. In action 710, the voltage of the current sense pin of the power stage IC is connect to a voltage level. In action 720, the pre-charge monitoring is performed by the power stage IC. As stated before, the voltage across the flying capacitor is detected by the power stage IC. After the pre-charge is completed, the current sense pin of the power stage IC is disconnected to the voltage level in action 730.

On the other hand, in action 740, the multiphase controller IC disables the current sense circuit and connect the current sense pin to a voltage reference. In action 750, the multiphase controller IC determines whether the pre-charge period of the corresponding power stage IC is finished according to the voltage of the current sense pin and a voltage threshold. For example, when the voltage of the current sense pin is less than a voltage threshold, it means that the pre-charge period of the corresponding power stage IC is finished, action 760 is performed. In action 760, the connection between the current sense pin and the voltage reference is disconnected and the current sense circuit is enabled. Although the flowchart of FIG. 7 shows a sequential action. It is obvious to persons skilled the art that these actions could be performed in any order.

It should be understood that, the circuit and the related components, circuit structures, signals, and waveforms described or shown above in the present disclosure are only for illustration purpose. However, the present disclosure is not limited thereto. Persons having ordinary skill in the art may understood that the control circuit of the present disclosure could be realized, according to practical applications, by any other circuits with different circuit structures, and thus controlled by different types of the corresponding signals to achieve the corresponding functions. For example, the compensation circuit, the ramp generation circuit, the comparison circuit and the logic circuit could be realized by a digital circuit, an analog circuit, a software, an automatic generation circuit by hardware description language, or a combination of the above.

It will be appreciated by persons skilled in the art that the present disclosure is not limited to what has been particularly shown and described herein above. Rather the scope of the present disclosure is defined by the claims and includes both combinations and sub-combinations of the various features described hereinabove as well as variations and modifications thereof which would occur to persons skilled in the art upon reading the foregoing description and which are not in the prior art.

What is claimed is:

1. A control circuit for a multiphase voltage regulator, comprising:
a switching control circuit configured to provide a control signal to control a plurality of power stage circuits, wherein each of the power stage circuit is configured to provide a phase current; and
a monitor circuit configured to receive a report signal from at least one of the power stage circuits, and determine whether the report signal indicates a pre-charge period of the corresponding power stage circuit is finished;
wherein after the report signal indicates that the pre-charge period of the corresponding power stage circuit is finished, the control signal is provided to power on the corresponding power stage circuit.

2. The control circuit of claim 1, wherein the monitor circuit is configured to compare the report signal with a voltage threshold and generate a comparison signal in response to the report signal and the voltage threshold; and determine whether the pre-charge period of the corresponding power stage circuit is finished according to the comparison signal.

3. The control circuit of claim 2, wherein the control circuit is an integrated circuit, further comprising:
a plurality of current sense pins, each of which is configured to receive a current sense signal from the corresponding power stage circuit, wherein a plurality of the report signals are received via the current sense pins; and
a plurality of voltage reference circuits coupled to the current sense pins, wherein each of the voltage reference circuit is configured to connect the corresponding current sense pin to a voltage reference.

4. The control circuit of claim 3, wherein the monitor circuit is further configured to determine whether the voltage of the corresponding current sense pin is less than the voltage threshold, wherein the pre-charge period of the corresponding power stage circuit is determined to be finished when the voltage of the corresponding current sense pin is less than the voltage threshold.

5. The control circuit of claim 3, wherein the monitor circuit is further configured to determine whether the voltage of the corresponding current sense pin is greater than the voltage threshold, wherein the pre-charge period of the corresponding power stage circuit is determined to be finished when the voltage of the corresponding current sense pin is greater than the voltage threshold.

6. The control circuit of claim 3, further comprising:
a current sense circuit configured to receive the current sense signals;
a plurality of first switches coupled between the current sense circuit and the corresponding current sense pins;
wherein during an initial period, the first switches are turned off to disable the current sense circuit.

7. The control circuit of claim 3, wherein the monitor circuit further comprises:
a plurality of second switches coupled between the corresponding current sense pins and the corresponding voltage reference circuits;
wherein after the initial period, the second switches are turned off, and the first switches are turned on to enable the current sense circuit.

8. The control circuit of claim 1, wherein the monitor circuit is configured to determine that the pre-charge period of the corresponding power stage circuit is finished when a falling edge of the report signal is detected.

9. The control circuit of claim 1, wherein the monitor circuit is configured to determine that the pre-charge period of the corresponding power stage circuit is finished when a rising edge of the report signal is detected.

10. A power stage circuit, comprising:
a switch circuit having at least one switch, wherein one of the at least one switch is configured to be coupled to a flying capacitor;
a driving control circuit configured to receive a control signal and provide at least one driving signal to a control terminal of the at least one switch;
a pre-charge monitor circuit configured to monitor a voltage across the flying capacitor; and
a report circuit configured to provide a report signal indicating a pre-charge period of the flying capacitor is finished.

11. The power stage circuit of claim 10, wherein the report circuit includes a switch coupled to a reference voltage, the switch is turned on when the voltage across the flying capacitor is not greater than a threshold, and the switch is turned off after the voltage across the flying capacitor is greater than the threshold.

12. The power stage circuit of claim 10, wherein the power stage circuit is an integrated circuit, further comprising:
a current sense pin configured to provide a current sense signal to a control circuit for a multiphase voltage regulator, wherein the report signal is provided via the current sense pin; wherein the switch is coupled between the reference voltage and the current sense pin.

13. The power stage circuit of claim 10, wherein after the switch is turned off, the report signal is less than a voltage threshold indicates that the pre-charge period of the corresponding power stage circuit is finished.

14. The power stage circuit of claim 10, wherein after the switch is turned off, a falling edge of the report signal indicates that the pre-charge period of the corresponding power stage circuit is finished.

15. The power stage circuit of claim 10, wherein after the switch is turned off, a rising edge of the report signal is detected indicates that the pre-charge period of the corresponding power stage circuit is finished.

16. The power stage circuit of claim 10, wherein the switch circuit further comprising:
a first high-side switch having a first terminal, a second terminal and a third terminal, wherein the first terminal of the first high-side switch is configured to receive an input voltage;
a first low-side switch having a first terminal, a second terminal and a third terminal, wherein the first terminal of the first low-side switch is coupled to the second terminal of the first high-side switch via the flying capacitor, and the second terminal of the first low-side switch is configured to be coupled to a reference voltage level;
a second high-side switch having a first terminal, a second terminal and a third terminal, wherein the first terminal of the second high-side switch is coupled to the second terminal of the first high-side switch;
a second low-side switch having a first terminal, a second terminal and a third terminal, wherein the first terminal of the second low-side switch is coupled to the second terminal of the second high-side switch, and the second terminal of the second low-side switch is configured to be coupled to the reference voltage level.

17. A multiphase voltage regulator, comprising:
a plurality of power stage circuits, each of which is configured to provide a phase current, wherein each power stage circuit comprise at least one power switch and a report circuit, wherein the report circuit is configured to provide a report signal; and
a control circuit coupled to the power stage circuits;
wherein the control circuit is configured to receive the report signal from at least one of the power stage circuits, determine whether the report signal indicates the pre-charge period of the corresponding power stage circuit is finished; and provide a control signal to the corresponding power stage circuit after it is determined that the report signal indicates the pre-charge period of the corresponding power stage circuit is finished.

18. The multiphase voltage regulator of claim 17, wherein the control circuit is further configured to compare the report signal with a voltage threshold and generate a comparison signal in response to the report signal and the voltage threshold; and determine whether the pre-charge period of the corresponding power stage circuit is finished according to the comparison signal.

19. The multiphase voltage regulator of claim 17, wherein the control circuit is further configured to determine whether all of the report signal indicates the pre-charge period of all of the corresponding power stage circuits are finished; and provide a plurality of the control signals to the power stage circuits after it is determined that the report signals indicate that the pre-charge period of all of the corresponding power stage circuits are finished.

20. A method for controlling a multiphase voltage regulator, comprises:
receiving a plurality of reporting signals from a plurality of power stage circuits;
determining whether the reporting signal indicates a pre-charge period of the corresponding power stage circuit is finished;
after the reporting signal indicating the pre-charge period of the corresponding power stage circuit is finished, providing a control signal to power on the corresponding power stage circuit.
